(19) United States
(12) Patent Application Publication
(10) Pub. No.: US 2010/0187220 A1
(43) Pub. Date: Jul. 29, 2010

(54) Micro-heaters and methods for manufacturing the same

(75) Inventors: Junhee Choi, Seongnam-si (KR); Andrei Zoulkarneev, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/385,285

(22) Filed: Apr. 3, 2009

(30) Foreign Application Priority Data
Jan. 23, 2009 (KR) 10-2009-0006223

(51) Int. Cl. H05B 3/10; H05B 3/16; H01C 17/08

(52) U.S. Cl. 219/543; 219/548; 29/611; 29/613; 29/620

(57) ABSTRACT

A micro-heater according to example embodiments may include a substrate, a metal pattern, and a passivation layer. The metal pattern may be spaced apart from the substrate. The passivation layer may be on the metal pattern and made of a solid solution including a material constituting the metal pattern. Alternatively, the passivation layer may be on the substrate and the metal pattern. A method for manufacturing a micro-heater according to example embodiments may include arranging a metal pattern so as to be spaced apart from a substrate. A first passivation layer may be formed on the substrate and the metal pattern. A voltage may be applied to the metal pattern to heat the metal pattern. As a result, a material constituting the metal pattern may diffuse into the first passivation layer to form a second passivation layer.

### CROSS-REFERENCE TO RELATED APPLICATION

This application claims priority under 35 U.S.C. §119 to Korean Patent Application No. 10-2009-0006223, filed on Jan. 23, 2009, the entire contents of which are incorporated herein by reference.

### BACKGROUND

1. Field

Example embodiments of the present application relate to micro-heaters and methods for manufacturing the same.

2. Description of the Related Art

A conventional micro-heater is used to locally heat the surface of a substrate to a high temperature and may be applied to a broad range of electronic devices (e.g., carbon nanotube transistors, low-temperature polycrystalline silicon or thin film transistors, TE field emission sources of a backlight unit, which require high-temperature fabrication processes or high-temperature operations). Substances may also be synthesized on a micro-heater using the heat applied to a heating element of the micro-heater.

### SUMMARY

Example embodiments herein relate to a micro-heater having a passivation layer that protects a heating element of the micro-heater chemically and/or mechanically. Example embodiments also relate to methods for manufacturing such a micro-heater.

A micro-heater according to example embodiments may include a substrate; a metal pattern spaced apart from the substrate; and a passivation layer on the metal pattern. The passivation layer on the metal pattern may be made of a solid solution that includes a material constituting the metal pattern. Alternatively, the passivation layer may be on the substrate and the metal pattern.

A method for manufacturing a micro-heater according to example embodiments may include arranging a metal pattern so as to be spaced apart from a substrate; and forming a first passivation layer on the metal pattern. The method may further include applying a voltage to the metal pattern to heat the metal pattern; and diffusing a material constituting the metal pattern into the first passivation layer to form a second passivation layer.

### BRIEF DESCRIPTION OF THE DRAWINGS

The above and other aspects, features, and advantages of example embodiments may become more apparent when the following detailed description is read in conjunction with the accompanying drawings in which:

FIG. 1 is a perspective view of a micro-heater according to example embodiments;

FIG. 2A is a cross-sectional view taken along line A-A′ of FIG. 1;

FIG. 2B is a cross-sectional view taken along line B-B′ of FIG. 1;

FIGS. 3A and 3B are cross-sectional views illustrating a method for manufacturing a micro-heater according to example embodiments;

FIGS. 4A to 4D are cross-sectional views illustrating another method for manufacturing a micro-heater according to example embodiments; and

FIG. 5 is a graph showing current-voltage characteristics of a micro-heater according to example embodiments.

### DETAILED DESCRIPTION

Example embodiments will be described more fully hereinafter with reference to the accompanying drawings. However, example embodiments may be embodied in many different forms and should not be construed as limited to the examples set forth herein. In the description, details of well-known features and techniques may have been omitted for purposes of brevity. In the drawings, like reference numerals denote like elements. Additionally, the shape, size, and spacing of various features/regions in the drawing may have been exaggerated for clarity.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a”, “an,” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

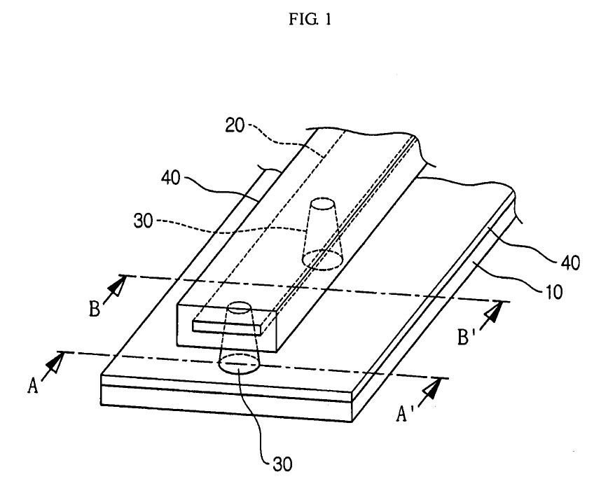

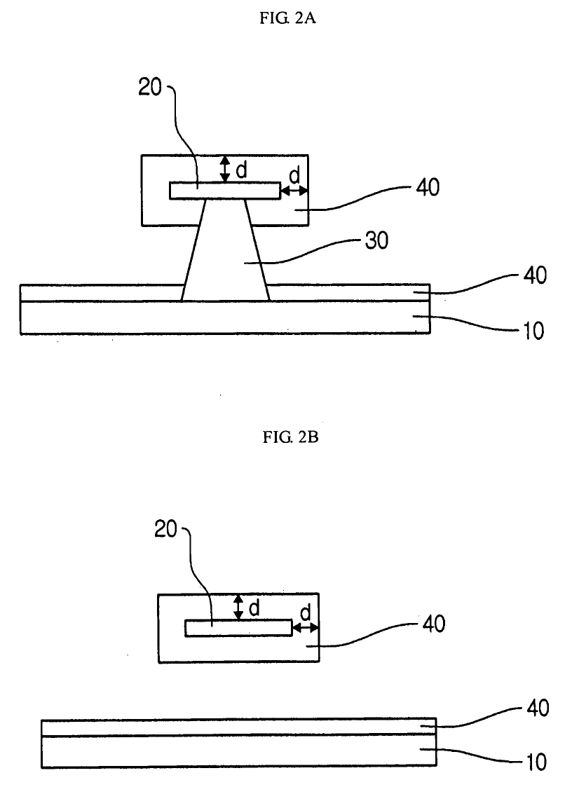

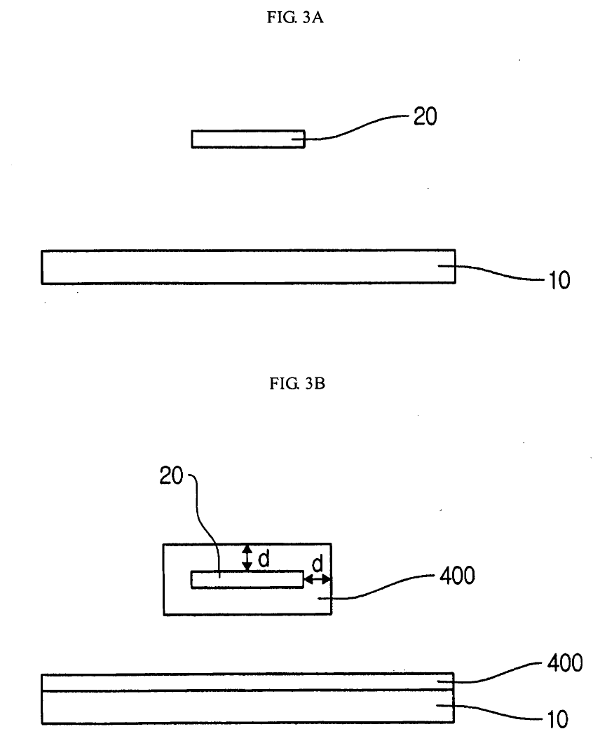

FIG. 1 is a perspective view of a micro-heater according to example embodiments. FIGS. 2A and 2B are cross-sectional views taken along lines A-A′ and B-B′ of FIG. 1, respectively. Referring to FIGS. 1 and 2, the micro-heater may include a substrate 10, a metal pattern 20, and a passivation layer 40. The substrate 10 may be made of a glass material or another suitable material. When the substrate 10 is made of a glass material, radiant heat (e.g., visible light, infrared rays) may be transmitted through the substrate 10. Furthermore, the substrate 10 may be formed to have a relatively large area.

The metal pattern 20 may be formed on the substrate 10 while being spaced apart from the substrate 10. The metal pattern 20 may be formed as an elongated shape extending linearly on the substrate 10. However, the shape of the metal pattern 20 is not limited thereto and may be in the form of other shapes including a different polygonal shape or other closed-surface shape. The metal pattern 20 may be made of molybdenum (Mo), tungsten (W), silicon carbide (SiC), or another suitable material. The metal pattern 20 may act as a heating element of the micro-heater. As a result, if a voltage is applied to the metal pattern 20, the metal pattern 20 may generate light and heat.

The metal pattern 20 may be supported by one or more supports 30 formed between the substrate 10 and the metal pattern 20. The one or more supports 30 may allow the metal pattern 20 to be fixed on the substrate 10 while keeping the metal pattern 20 spaced apart from the substrate 10. The supports 30 may be made of a material having relatively low thermal conductivity so as to reduce or prevent the loss of heat generated by the metal pattern 20. For example, the supports 30 may be made of an insulating material (e.g., silicon oxide (SiOₓ) or silicon nitride (e.g., Si₃N₄)).

The passivation layer 40 may be formed on the substrate 10 and the metal pattern 20. The passivation layer 40 on the metal pattern 20 may be formed to completely cover and surround the metal pattern 20 except for regions at which the metal pattern 20 is in contact with the supports 30. The passivation layer 40 may be formed to a thickness, d, of about 100 nm or less on the metal pattern 20.

The passivation layer 40 may be a layer which allows the metal pattern 20 to be passivated chemically and/or mechanically. For example, the passivation layer 40 may protect the metal pattern 20 from external materials, so as to reduce or prevent a material constituting the metal pattern 20 from being broken down by a chemical reaction. Furthermore, the passivation layer 40 may reduce or prevent the metal pattern 20 from being mechanically deformed.

To prevent the metal pattern 20 from being exposed to external materials, the passivation layer 40 may be made of a material having a relatively low diffusion coefficient (e.g., relatively low diffusion coefficient for oxygen (O₂) gas and/or hydrogen (H₂) gas). Additionally, the passivation layer 40 may be made of a material having relatively high mechanical stability (e.g., relatively high Young's modulus). Furthermore, to facilitate the application of power to the metal pattern 20, the passivation layer 40 may be made of a material having a relatively low resistance. For example, the passivation layer 40 may be made of a material including amorphous silicon (Si), silicon oxide, silicon oxynitride, silicon carbide (SiC), titanium nitride (TiN), indium tin oxide (ITO), or other suitable materials.

When the passivation layer 40 is formed of silicon oxide or silicon oxynitride, the materials may be expressed by formula SiOₓ (0<x≦2) or formula SiOₓN_{y} (0<x≦2, y>0), respectively. In the formulae, “x” may have a value closer to zero than two to obtain a passivation layer 40 having a relatively low resistance.

The passivation layer 40 may also be made of a material doped with a dopant (e.g., phosphorus (P) or boron (B)). For example, the passivation layer 40 may be doped with P using phosphine (PH₃) or B using diborane (B₂H₆). By doping the passivation layer 40 with a dopant, the resistance of the passivation layer 40 may be further decreased.

In an alternative embodiment, the passivation layer 40 may only be disposed on the metal pattern 20 instead of also being on the substrate 10. In such a case, the passivation layer 40 on the metal pattern 20 may be a solid solution formed by the diffusion of a material constituting the metal pattern 20 into the preliminary passivation layer. For example, the passivation layer 40 may be a silicide. Such a solid solution has a relatively high conductivity. Therefore, the solid solution may be used as an electrode when the micro-heater is applied to a device.

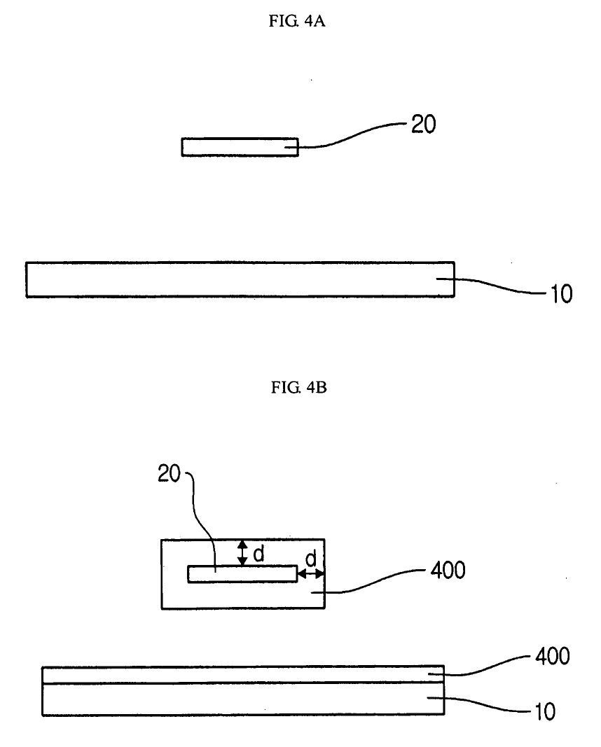

FIGS. 3A and 3B are cross-sectional views illustrating a method for manufacturing a micro-heater according to example embodiments. Referring to FIG. 3A, a metal pattern 20 may be arranged so as to be spaced apart from the substrate 10. For example, the metal pattern 20 may be supported by one or more supports 30 (see FIG. 1) while being spaced apart from the substrate 10. The substrate 10 may be made of glass or another suitable material. The metal pattern 20 may include molybdenum (Mo), tungsten (W), silicon carbide (SiC), or other suitable materials.

Referring to FIG. 3B, a first passivation layer 400 may be formed on the metal pattern 20 and the substrate 10. The first passivation layer 400 on the metal pattern 20 may be formed to a thickness, d, of about 100 nm or less. The first passivation layer 400 may be formed using sputtering, chemical vapor deposition (CVD), or other suitable methods. For example, the first passivation layer 400 may be deposited using plasma enhanced CVD or thermal CVD.

The first passivation layer 400 may be made of a material having a relatively low diffusion coefficient for gas so as to protect the metal pattern 20 from exposure to an external gas. Additionally, the first passivation layer 400 may be made of a material having a relatively high mechanical stability. Furthermore, to facilitate the application of power to the metal pattern 20, the first passivation layer 40 may be made of a material having a relatively low resistance.

For example, the first passivation layer 400 may be made of a material including amorphous silicon (Si), silicon oxide, silicon oxynitride, silicon carbide (SiC), titanium nitride (TiN), or indium tin oxide (ITO). When the first passivation layer 400 is made of silicon oxide or silicon oxynitride, the materials may be expressed by formula SiOₓ (0<x≦2) or formula SiOₓN_{y} (0<x≦2, y>0), respectively. In the formulae, “x” may have a value closer to zero than two. The first passivation layer 400 may also be doped with a dopant (e.g., phosphorus (P) or boron (B)).

Since the first passivation layer 400 has a relatively high chemical and/or mechanical stability and is formed on the metal pattern 20, it is possible to reduce or prevent the possibility of the metal pattern 20 from being broken down or deformed. As a result, it is possible to obtain a micro-heater having chemical and/or mechanical stability. Furthermore, the micro-heater may be applied to a device having a p-n junction, a micro thermionic emission source, a thin film transistor, a patterning method using a micro-heater, or other appropriate applications.

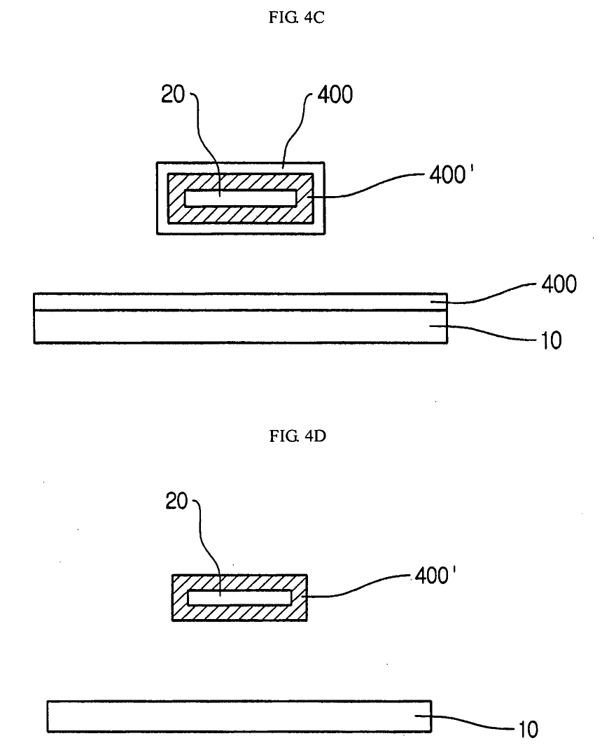

FIGS. 4A to 4D are cross-sectional views illustrating another method for manufacturing a micro-heater according to example embodiments. Referring to FIGS. 4A and 4B, a metal pattern 20 may be arranged so as to be spaced apart from a substrate 10, and a first passivation layer 400 may be formed on the metal pattern 20 and the substrate 10. The processes illustrated in FIGS. 4A and 4B may be identical to those described above with reference to FIGS. 3A and 3B, respectively. Therefore, the detailed description with regard to FIGS. 4A and 4B will be omitted for the purpose of brevity.

Referring to FIG. 4C, the metal pattern 20 may be heated by applying a voltage thereto. When the metal pattern 20 is heated, a portion of the material constituting the metal pattern 20 may diffuse into the first passivation layer 400 in contact with the metal pattern 20. The diffused material of the metal pattern 20 may react with the material constituting the first passivation layer 400, thereby forming a second passivation layer 400′.

The second passivation layer 400′ may be a solid solution that includes the material of the metal pattern 20 and the material of the first passivation layer 400. For example, when the metal pattern 20 is made of molybdenum (Mo) and the first passivation layer 400 is made of a material including silicon (Si), the second passivation layer 400′ may be made of molybdenum silicide (MoSiₓ). One or more silicon (Si) layers may be included in the second passivation layer 400′ depending on processing conditions.

Referring to FIG. 4D, the first passivation layer 400 on the substrate 10 and the remaining first passivation layer 400 on the metal pattern 20 may be removed. For example, the first passivation layer 400 may be removed using wet etching or other suitable methods.

The second passivation layer 400′ has a different composition from that of the first passivation layer 400. As a result, the second passivation layer 400′ may have selectivity with respect to an etchant for etching the first passivation layer 400. Accordingly, only the first passivation layer 400 may be selectively removed from the substrate 10 and the metal pattern 20, thereby leaving only the second passivation layer 400′ on the metal pattern 20. Thus, the first passivation layer 400 may be removed from the substrate 10 by etching. The second passivation layer 400′ may have a relatively high conductivity. Therefore, when the micro-heater is applied to a device, the second passivation layer 400′ may be used as an electrode.

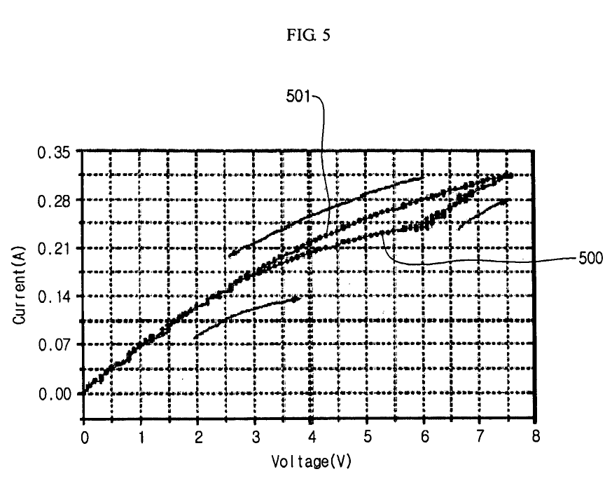

FIG. 5 is a graph showing current-voltage characteristics of a micro-heater according to example embodiments. Graph 500 shown in FIG. 5 illustrates current values measured while increasing voltage, while graph 501 illustrates current values measured while decreasing voltage. In a micro-heater that is chemically unstable, a metal pattern may break down due to the chemical reaction with external materials when the voltage is increased, thereby resulting in a decrease in current. However, as shown in FIG. 5, a micro-heater having a passivation layer shows stable voltage-current characteristics even when the voltage is increased.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

What is claimed is:

1. A micro-heater comprising:
a substrate;
a metal pattern spaced apart from the substrate; and
a passivation layer on the metal pattern.

2. The micro-heater according to claim 1, wherein the passivation layer is a solid solution that includes a material constituting the metal pattern.

3. The micro-heater according to claim 2, wherein the solid solution further includes silicon, titanium, or tin.

4. The micro-heater according to claim 1, wherein the passivation layer includes amorphous silicon, silicon oxide, silicon oxynitride, silicon carbide, titanium nitride, or indium tin oxide.

5. The micro-heater according to claim 4, wherein the silicon oxide or silicon oxynitride is expressed by SiOₓ (0<x≦2) or SiOₓN_{y} (0<x≦2, y>0), respectively.

6. The micro-heater according to claim 4, wherein the passivation layer further includes phosphorus or boron.

7. The micro-heater according to claim 1, further comprising:
an additional passivation layer on the substrate.

8. The micro-heater according to claim 1, wherein the passivation layer has a thickness of about 100 nm or less.

9. The micro-heater according to claim 1, wherein the metal pattern includes tungsten, molybdenum, or silicon carbide.

10. A method for manufacturing a micro-heater, comprising:
arranging a metal pattern so as to be spaced apart from a substrate; and
forming a first passivation layer on the metal pattern.

11. The method according to claim 10, wherein the first passivation layer is formed by sputtering or chemical vapor deposition.

12. The method according to claim 10, wherein the first passivation layer has a thickness of about 100 nm or less.

13. The method according to claim 10, wherein the first passivation layer is made of a material including amorphous silicon, silicon oxide, silicon oxynitride, silicon carbide, titanium nitride, or indium tin oxide.

14. The method according to claim 13, wherein the silicon oxide or silicon oxynitride is expressed by SiOₓ (0<x≦2) or SiOₓN_{y} (0<x≦2, y>0), respectively.

15. The method according to claim 13, wherein the first passivation layer further includes phosphorus or boron.

16. The method according to claim 10, wherein the metal pattern includes tungsten, molybdenum, or silicon carbide.

17. The method according to claim 10, further comprising:
applying a voltage to the metal pattern to heat the metal pattern; and
diffusing a material constituting the metal pattern into the first passivation layer to form a second passivation layer.

18. The method according to claim 17, wherein the second passivation layer is a solid solution.

19. The method according to claim 17, further comprising:
removing the first passivation layer remaining after the formation of the second passivation layer.

20. The method according to claim 19, wherein the first passivation layer is removed by wet etching.
